(19) United States
(12) Patent Application Publication
(10) Pub. No.: US 2016/0218932 A1
(43) Pub. Date: Jul. 28, 2016

(54) METHOD AND APPARATUS FOR CONTROLLING LIFE-CYCLE OF PROCESS FOR NETWORK OPERATING SYSTEM

(71) Applicant: ELECTRONICS AND TELECOMMUNICATIONS RESEARCH INSTITUTE, Daejeon (KR)

(72) Inventors: Seong MOON, Daejeon (KR); Ho Yong RYU, Daejeon (KR); Jae Chan SHIM, Daejeon (KR)

(21) Appl. No.: 14/997,696

(22) Filed: Jan. 18, 2016

(30) Foreign Application Priority Data
Jan. 26, 2015 (KR) 10-2015-0011955

(51) Int. Cl. H04L 12/24; H04L 29/08

(52) U.S. Cl. CPC H04L 41/14; H04L 67/16

(57) ABSTRACT

A method and an apparatus for controlling a life-cycle of a process for a network operating system. The method includes, by a process manager, transmitting a first initialize command to processes in a system service space and registering processes that respond to the first initialize command when an operation of the network operating system starts; confirming failure statuses of the registered processes and controlling the registered processes to execute a designated service; transmitting, when the processes in the system service space execute the service, a second initialize command to processes in a networking service space and a networking application space and registering processes that respond to the second initialize command; and confirming failure statuses of the processes registered in response to the second initialize command and allocating roles to the respective processes in the networking service space and the networking application space.

### CROSS-REFERENCE TO RELATED APPLICATIONS

This application claims priority to and the benefit of Korean Patent Application No. 10-2015-0011955 filed in the Korean Intellectual Property Office on Jan. 26, 2015, the entire contents of which are incorporated herein by reference.

### BACKGROUND OF THE INVENTION

1. Field of the Invention

The present invention relates to a method and an apparatus for controlling a life-cycle of a process for a network operating system, and to a technique that controls life-cycles of processes of a network operating system.

2. Description of Related Art

In general, the network operating system represents a software package that is mounted on network equipment such as a router and a switch to control detailed functions of the equipment.

A software architecture of the network operating system may be divided into a system service area, a network service area, and a network protocol area.

The network operating system controls life-cycles of processes that operate in various areas by using a dedicated process such as a process manager. However, the process manager in the related art performs only a function to start and terminate the processes.

The processes in the network operating system operate dependently on each other. Therefore, the life-cycles need to be controlled by considering inter-dependency among the respective processes, but there is a problem in that the process manager in the related art controls the life-cycles without considering the inter-dependency among the respective processes.

### BRIEF SUMMARY OF THE INVENTION

The present invention has been made in an effort to provide a method and an apparatus for controlling a life-cycle of a process for a network operating system which control processes regardless of roles allocated to the processes when a process manager controls life-cycles of processes that operate in the network operating system.

The present invention has also been made in an effort to provide a method and an apparatus for controlling a life-cycle of a process for a network operating system which allow a process manager to control processes without determining dependency among processes that operate in the network operating system.

An exemplary embodiment of the present invention provides a method for controlling a life-cycle of a process of a network operating system including, by a process manager, transmitting a first initialize command to processes in a system service space of the network operating system and registering processes that respond to the first initialize command when an operation of the network operating system starts; confirming failure statuses of the processes registered in response to the first initialize command and controlling the registered processes to execute a designated service; transmitting, when the processes in the system service space execute the service, a second initialize command to processes in a networking service space and a networking application space and registering processes that respond to the second initialize command; and confirming failure statuses of the processes registered in response to the second initialize command and allocating roles to the respective processes in the networking service space and the networking application space.

The process in the system service space may provide a service designated to correspond to any one of inter process communication (IPC), an event, a checkpoint, a task, and a memory to the processes in the networking service space and the networking application space.

The process in the networking service space may provide to the processes in the networking application space a service corresponding to a role allocated to correspond to any one of a command manager, a routing information base (RIB) manager, a link manager, and a policy manager.

The process in the networking application space may process an operation corresponding to a role allocated to correspond to any one application protocol among a routing information protocol (RIP), an open shortest path first (OSPF) protocol, a border gateway protocol (BGP), a link aggregation control protocol (LACP), and a spanning tree protocol (STP).

The method may further include, by the process manager, after the allocating of the roles to the respective processes in the networking service space and the networking application space, receiving a response from at least one of the processes to which the roles are allocated; generating a status change event for role performance of the process receiving the response; and transmitting the status change event to other processes except for the process receiving the response.

The method may further include confirming the respective processes in the networking service space and the networking application space to confirm statues of other processes by the status change event.

The method may further include confirming, by at least one of the respective processes in the networking service space and the networking application space, role performance statuses of other processes providing a service required to perform the role of the corresponding process by the status change event.

The method may further include when another process providing the service required to perform the role of the corresponding process starts performing the role, sending, by the corresponding process, the response to the process manager.

The method may further include responding, by the processes allocated with the roles by the process manager, to the process manager and thereafter, performing the allocated roles.

The method may further include by the process manager, when detecting failures of the processes that perform the roles allocated by the process manager, generating a failure occurrence event for the process of which the failure is detected; transmitting the failure occurrence event to the processes in the networking service space and the networking application space; and performing a failure recovery operation for the process of which the failure occurs.

The method may further include confirming, by the respective processes in the networking service space and the networking application space, the process of which the failure occurs by the failure occurrence event.

The method may further include when the process of which the failure occurs is the process providing the service required to perform the role of the corresponding process, stopping performing the role of the corresponding process; and performing, by the corresponding process, the failure recovery operation.

The method may further include: by the process manager, transmitting a role stop command to the processes that operate in the networking service space and the networking application space; generating status events for processes that respond to the role stop command and transmitting the generated status events to the processes in the networking service space and the networking application space; when all of the roles of the processes that operate in the networking service space and the networking application space stop, controlling the respective processes to end; and controlling the processes that operate in the system service space to end after all of the processes in the networking service space and the networking application space end.

The method may further include confirming the respective processes in the networking service space and the networking application space, the process that stops performing the role by the status change event.

The method may further include when the process that stops performing the role is the process providing the service required to perform the role of the corresponding process, stopping performing the role of the corresponding process.

Another exemplary embodiment of the present invention provides an apparatus for controlling a life-cycle of a process for a network operating system, including: multiple processes that operate in a system service space, a network service space, and a network application space of the network operating system; and a process manager controlling life-cycles of the multiple processes.

The process manager may control execution of services of the processes in the system service space and thereafter, allocate roles to the respective processes in the network service space and the network application space at the time of starting an operation of the network operating system and control the respective processes in the network service space and the network application space to end and thereafter, control the processes in the system service space to end.

According to exemplary embodiments of the present invention, a life-cycle of a process is controlled for each area of a network operating system, and as a result, a process manager can control life-cycles of processes that operate in the network operating system.

According to the exemplary embodiments of the present invention, the respective processes themselves operate by verifying statuses of processes having dependency through a status change event, and as a result, the process manager can control the processes without determining the dependency among the processes that operate in the network operating system.

In the present invention, the process manager controls the processes regardless of roles allocated to the processes when controlling the life-cycles of the processes that operate in the network operating system, thereby reducing cost for developing the processes that play various roles. Further, software extensibility such as removing an unrequired process or adding a new process is increased by managing the processes regardless of the dependency among the processes to ultimately enable a modulation architecture of the network operating system.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a configuration of an apparatus for controlling a life-cycle of a process for a network operating system according to the present invention.

FIG. 2 is a flowchart illustrating a first exemplary embodiment of a method for controlling a life-cycle of a process for a network operating system according to the present invention.

FIG. 3 is a flowchart illustrating a second exemplary embodiment of the method for controlling a life-cycle of a process for a network operating system according to the present invention.

FIG. 4 is a flowchart illustrating a third exemplary embodiment of the method for controlling a life-cycle of a process for a network operating system according to the present invention.

FIG. 5 is a flowchart illustrating a fourth exemplary embodiment of the method for controlling a life-cycle of a process for a network operating system according to the present invention.

FIG. 6 is a diagram illustrating a computing system to which the apparatus according to the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is noted that technical terms used in the specification are used to just describe a specific exemplary embodiment and do not intend to limit the present invention. Further, unless otherwise defined, the technical terms used in the specification should be interpreted as meanings generally appreciated by those skilled in the art and should not be interpreted as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

Unless otherwise apparently specified contextually, a singular expression used in the specification includes a plural expression. In the specification, a term such as “comprising” or “including” should not be interpreted as necessarily including all various components or various steps disclosed in the specification, and it should be interpreted that some component or some steps among them may not be included or additional components or steps may be further included.

Terms including ordinal numbers, such as ‘first’ and ‘second’, used in the specification can be used to describe components, but the components should not be limited by the terms. The above terms are used only for distinguishing one component from the other component. For example, a first component may be named a second component and similarly, the second component may also be named the first component, without departing from the scope of the present invention.

Hereinafter, exemplary embodiments of the present invention will be described in detail with reference to the accompanying drawings, in which like reference numerals refer to like or similar elements regardless of reference numerals and a duplicated description thereof will be omitted.

In describing the present invention, when it is determined that the detailed description of the publicly known art related to the present invention may obscure the gist of the present invention, the detailed description thereof will be omitted. Further, it is noted that the accompanying drawings are only for easily understanding the spirit of the present invention and it should not be interpreted that the spirit of the present invention is limited by the accompanying drawings.

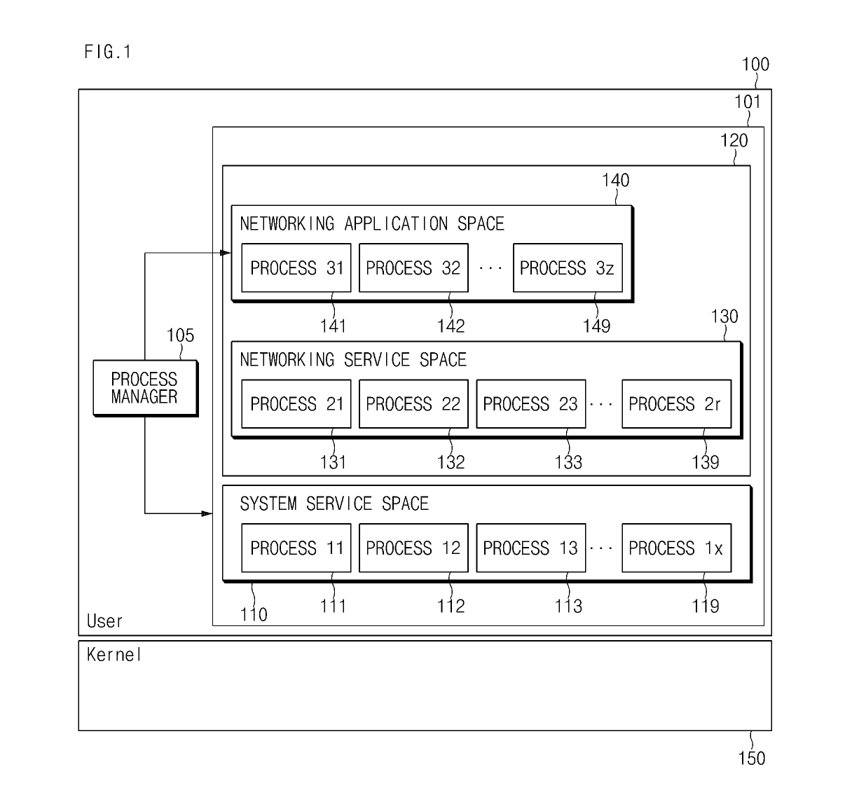

FIG. 1 is a diagram illustrating a configuration of an apparatus for controlling a life-cycle of a process for a network operating system according to the present invention.

Referring to FIG. 1, the network operating system applied to the present invention may generally be divided into a user space 100 and a kernel space 150.

First, the user space 100 is a space with an application service or application service data, and other information required to perform or consume the application service or the application service data. Herein, a service, service data, and an application program may be present in the user space 100. As one example, various types of single software, program codes, data, or a logic process configured by combinations thereof may be present in the user space 100.

The kernel space 150 is a space in which system resources commonly provided in the operating system are present. As one example, resources that perform file input/output, network input/output, memory management, process management, and the like may be present in the kernel space 150.

However, in the exemplary embodiment, an operation of controlling life-cycles of processes around the user space 100 will be described.

The user space 100 of the network operating system may be described by segmenting the user space 100 into a system service space 110, a networking service space 130 of a network space 120, and a networking application space 140.

First, the system service space 110 is a space on which software tools which may be commonly used by processes that operate in different spaces, for example, inter process communication (IPC), an event, a checkpoint, a task, and a memory are mounted.

Therefore, in the system service space 110, process11 111, process12 112, process13 113, . . . , process1X 119, and the like may operate to correspond to the software tools. As one example, the process11 111 may be an IPC process that plays a role of the IPC and the process12 112 may be an event process that plays a role of the event service.

In this case, the processes that operate in the system service space 110 may be used by the processes that operate in the networking service space 130 and the networking application space 140.

A command manager, a routing information base (RIB) manager, a link manager, and a policy manager are mounted on the networking service space 130 to provide services to the processes that operate in the networking application space 140. In other words, the command manager, the RIB manager, the link manager, the policy manager, and the like of the networking service space 130 provide services associated with common networking which may be used by various programs of the networking application space 140.

Therefore, in the networking service space 130, process21 131, process22 132, process23 133, . . . , process2Y 139, and the like may operate to correspond to the command manager, the RIB manager, the link manager, the policy manager, and the like. As one example, the process21 131 is the command manager that serves to process commands, the process22 132 is an RIB manager that serves to perform a service of a routing information base, and the process23 133 may correspond to the link manager that controls a port of a switch or an interface of a router.

The networking application space 140 represents a space on which application protocols actually controlling a network are mounted. The application protocols mounted on the networking application space 140 may correspond to layer 3 protocols such as a routing information protocol (RIP), an open shortest path first (OSPF) protocol, and a border gateway protocol (BGP) and layer 2 protocols such as a link aggregation control protocol (LACP) and a spanning tree protocol (STP).

Therefore, in the networking application space 140, process31 141, process32 142, . . . , process3Z 149, and the like may operate to correspond to the respective application protocols. As one example, the process31 141 may correspond to an RIPD which is a daemon process serving to process the RIP and the process32 142 may correspond to an LACPD which is a daemon process serving to process the LACP.

Meanwhile, the network operating system may include a process manager 105 that controls life-cycles of the processes that operate in the system service space 110, the networking service space 130, and the networking application space 140.

The process manager 105 may control a cycle including start, end, role performance, and the like of the processes of the system service space 110, the networking service space 130, and the networking application space 140 and process a status change event and/or a failure recovery of each of the processes.

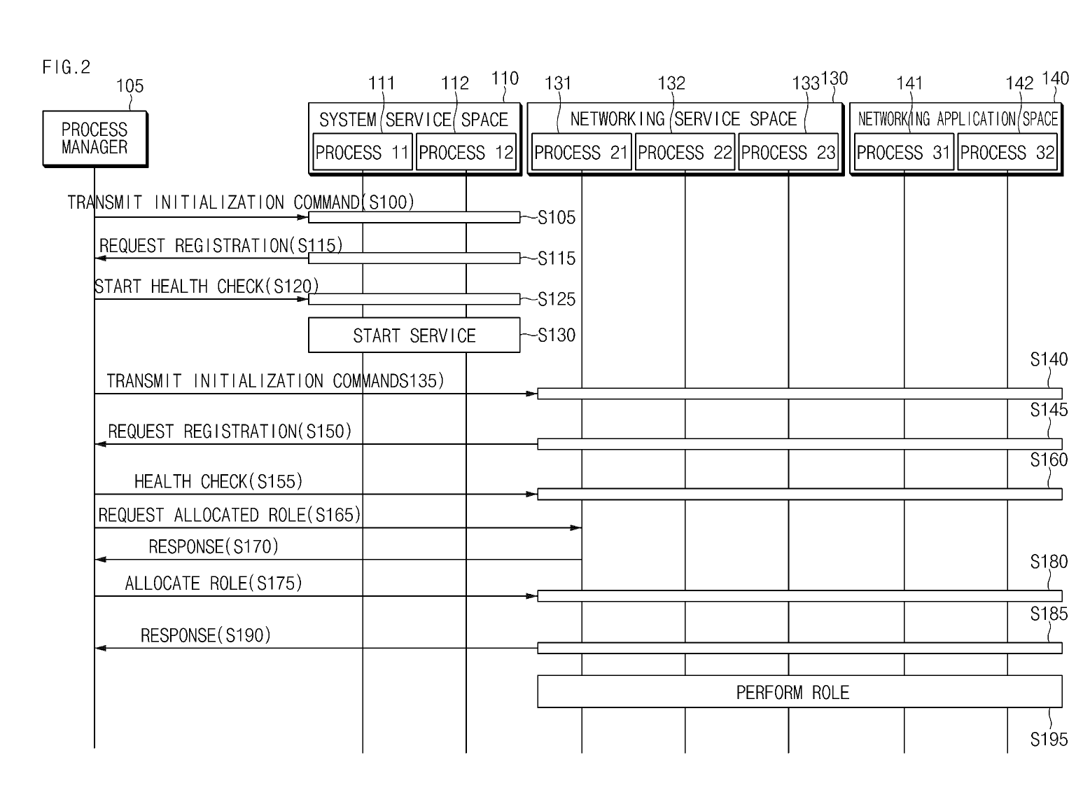

Therefore, an operation in which the process manager 105 controls the life-cycles of the respective processes that operate in the system service space 110, the networking service space 130, and the networking application space 140 will be described in more detail with reference to exemplary embodiments of FIGS. 2 to 5.

In the exemplary embodiments of FIGS. 2 to 5, some processes that operate in the system service space 110, the networking service space 130, and the networking application space 140 in the exemplary embodiment will be described and the exemplary embodiment is not limited to any one exemplary embodiment. Further, it is natural that a processing order and a status may be changed according to the types of the processes that operate in the system service space 110, the networking service space 130, and the networking application space 140.

First, FIG. 2 is a flowchart illustrating a first exemplary embodiment of a method for controlling a life-cycle of a process for a network operating system according to the present invention. In particular, FIG. 2 illustrates an operation in which the process manager 105 controls a start cycle for the processes of the system service space 110, the networking service space 130, and the networking application space 140.

When the operation of the network operating system starts, the process manager 105 determines whether to search a control process list which needs to be controlled thereby and determines what processes to first initialize by using the searched control process list. In this case, the process manager 105 first initializes the processes of the system service space 110 and thereafter, when the processes of the system service space 110 start the services, the process manager 105 initializes the processes of the networking service space 130 and the networking application space 140.

Therefore, the process manager 105 transmits initialize commands to the process11 111 and the process12 112 of the system service space 110 as illustrated in FIG. 2 (S100). In this case, the process11 111 and the process12 112 of the system service space 110 receive the initialize commands from the process manager 105 (S105), performs a preparation operation (S110), and transmits a registration request to the process manager 105 (S115). The process manager 105 registers the process11 111 and the process12 112 according to the request during ‘S115’.

Thereafter, the process manager 105 transmits the respective processes to health check start commands for the registered process11 111 and process12 112 (S120). Herein, health check is used to sense failures of the processes afterwards.

The process11 111 and the process12 112 examine health statuses thereof according to the health check commands from the process manager 105 (S125). Although not illustrated in FIG. 2, the process11 111 and the process12 112 periodically report a result of health check to the process manager 105. Thereafter, the process11 111 and the process12 112 execute the services thereof (S130). As one example, the process11 111 executes an IPC service and the process12 112 executes the event service. The process11 111 and the process12 112 report a result of the service execution during ‘S130’ to the process manager 105 in real time.

Meanwhile, after the processes of the system service space 110 start the services, the process manager 105 simultaneously transmits the initialize commands to the processes of the networking service space 130, for example, the processes of the process21 131, the process22 132, and the process23 133 and the processes of the networking application space 140, for example, the process31 141 and the process32 142 (S135).

In this case, the process21 131 to the process23 133 of the networking service space 130 and the process31 141 and the process32 142 of the networking application space 140 receive the initialize commands from the process manager 105 (S140), performs the preparation operation (S145), and transmits the registration request to the process manager 105 (S150). The process manager 105 registers the process21 131 to the process23 133 and the process31 141 and the process32 142 according to the request during ‘S150’.

Thereafter, the process manager 105 transmits a health check start command for the registered process21 131 to process23 133 and the process31 141 and the process32 142 to the respective processes (S155). Herein, health check is used to sense the failures of the processes afterwards. The process21 131 to, the process23 133 and the process31 141 and the process32 142 examine health statuses thereof according to the health check commands from the process manager 105 (S160). Although not illustrated in FIG. 2, the process21 131 to the process23 133, and the process31 141, and the process32 142 periodically report a result of health check to the process manager 105. Thereafter, the process21 131 to the process23 133 and the process31 141 and the process32 142 stand by until being allocated with the roles from the process manager 105.

The process manager 105 determines what roles to allocate to the registered process21 131 to 23 133 and processes 31 141 and 32 142. In this case, the process manager 105 requests the roles allocated to the respective processes to the process21 131 that serves to process the command, that is, the command manager (S165) and receives a response from the process21 131 (S170).

Thereafter, the process manager 105 determines what roles to allocate to the registered process21 131 to 23 133 and processes 31 141 and 32 142 from the response of the process21 131 to allocate the roles to the respective processes (S170). Of course, the process manager 105 may acquire information on the roles allocated to the respective processes by other various methods.

The process21 131 to the process23 133 and, the process31 141 and the process32 142 prepares for performing the roles allocated thereto (S185) when receiving the role information allocated from the process manager 105 (S180). When the preparation for performing the roles by the respective processes is completed, a response is sent to the process manager 105 (S190) and the roles allocated to the respective processes are performed (S195).

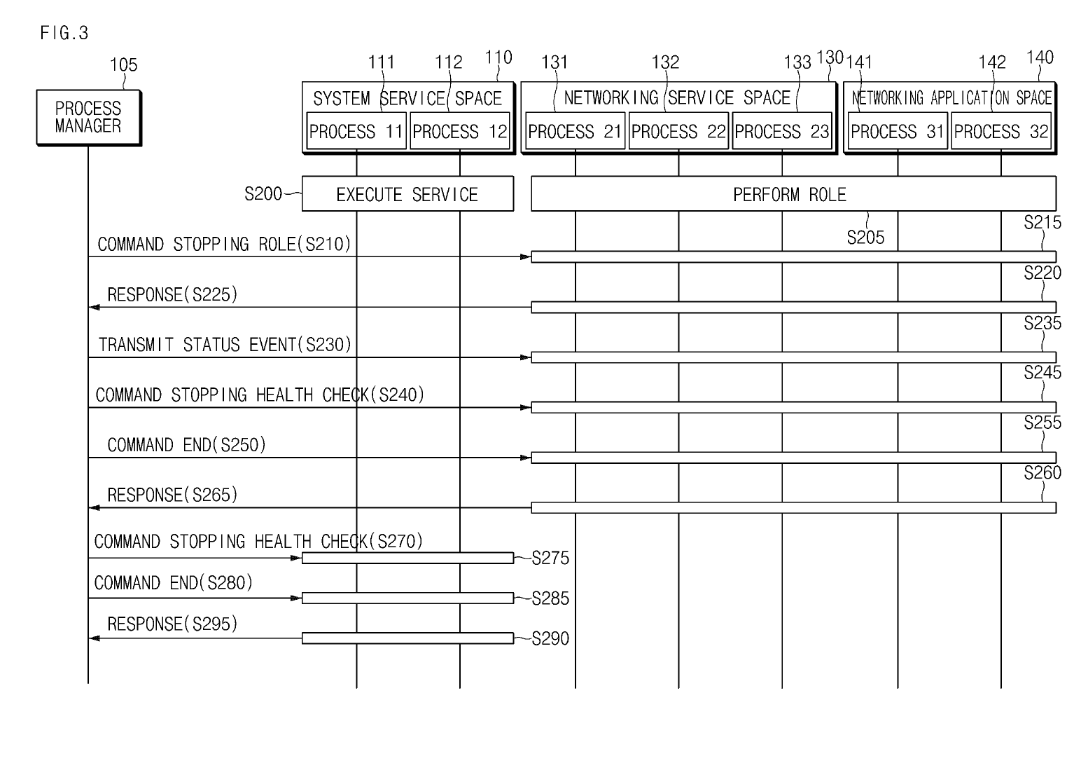

FIG. 3 is a flowchart illustrating a second exemplary embodiment of the method for controlling a life-cycle of a process for a network operating system according to the present invention. In particular, FIG. 3 illustrates an operation in which the process manager 105 controls an end cycle for the processes of the system service space 110, the networking service space 130, and the networking application space 140.

The process11 111 and the process12 112 of the system service space 110 execute the services (S200), and the processes perform the roles allocated thereto (S205). When the process manager 105 decides to terminate processes since failure or switchover, the process manager 105 first preferentially terminates the processes of the networking service space 130 and the networking application space 140 and thereafter, terminates the processes of the system service space 110.

In other words, the process manager 105 transmits a role stopping command to the process21 131 to the process23 133 and the process31 141 and the process32 142 that operate in the networking service space 130 and the networking application space 140 as illustrated in FIG. 3 (S210). In this case, the process21 131 to the process23 133 and the process31 141 and the process32 142 stop the services performed thereby (S220) and send the response to the process manager 105 (S225) when receiving the role, stopping command from the process manager 105 (S215).

When the process manager 105 confirms that the process21 131 to the process23 133 and the process31 141 and the process32 142 which make a response during ‘S225’ stop to operate, the process manager 105 generates a state change event indicating that the respective processes stop to perform the roles, for example, ‘event_status_change( )’ to transmit the generated ‘event_status_change( )’ to the process21 131 to the process23 133 and the process31 141 and the process32 142 (S230). Herein, that the process21 131 to the process23 133 and the process31 141 and the process32 142 may confirm that the operations of the associated processes stop from the status change event during ‘S230’ (S235).

Thereafter, the process manager 105 transmits a health check stop command for the process21 131 to the process23 133 and the process31 141 and the process32 142 (S240). Therefore the process21 131 to the process23 133 and the process31 141 and the process32 142 stop health check performed thereby according to the command during ‘S240’ (S245).

The process manager 105 transmits a terminate command for the process21 131 to the process23 133 and the process31 141 and the process32 142 (S250). In this case, when the process21 131 to the process23 133 and the process31 141 and the process32 142 receive the terminate command from the process manager 105 (S255), the process21 131 to the process23 133 and the process31 141 and the process32 142 perform a termination procedure of each process (S260) and send a response to the process manager 105 (S265).

When the process manager 105 confirms terminate statuses of the process21 131 to the process23 133 and the process31 141 and the process32 142 during ‘S265’, the process manager 105 transmits the health check stop command to the process11 111 and the process12 112 of the system service space (S270). In this case, the process11 111 and the process12 112 stop health check performed thereby according to the command during ‘S270’ (S275).

The process manager 105 transmits the terminate command, to the process11 111 and the process12 112 (S280). In this case, when the process11 111 to the process12 112 receive the terminate command from the process manager 105 (S285), the process11 111 and the process12 112 perform the termination procedure of each process (S290) and send the response to the process manager 105 (S295).

Therefore, the process manager 105 confirms the terminate statuses of the processes that operate in the system service space during ‘S295’ and thereafter, the process manager 105 himself/herself ends.

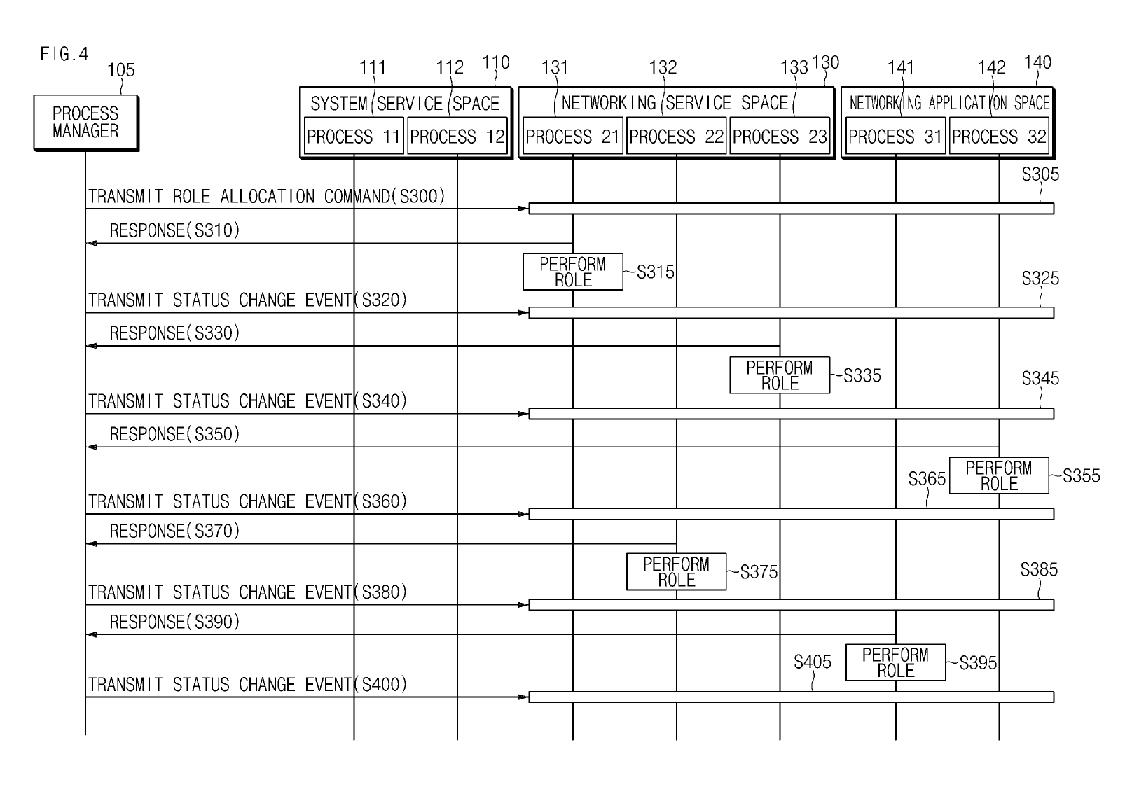

FIG. 4 is a flowchart illustrating a third exemplary embodiment of the method for controlling a life-cycle of a process for a network operating system according to the present invention. In particular, FIG. 4 illustrates an operation in which the process manager 105 processes the status change event in allocating the roles to the processes of the system service space 110, the networking service space 130, and the networking application space 140.

Herein, since the process31 141 of the networking application space 140 as the RIPD use the services of the process22 (RIB manager) 132 and the process23 (link manager) 133 of the networking service space 130, it is assumed that the process31 141 has dependency on the process22 132 and the process23 133 and since the process32 as the LACPD uses the process23 (link manager) 133 of the networking service space 130, it is assumed that the process32 has dependency on only the process23 133.

Therefore, the process manager 105 determines what roles to allocate to the processes registered with respect to the networking service space 130 and the networking application space 140, that is, the process21 131 to the process23 133 and the process31 141 and the process32 142 to allocate the roles to the respective processes as illustrated in FIG. 4 (S300). Of course, the process manager 105 may acquire information on the roles allocated to the respective processes by other various methods.

The process21 131 to the process23 133 and the process31 141 and the process32 142 prepares for performing the roles allocated thereto when receiving the role information allocated from the process manager 105 (S305). When the preparation is completed, the respective processes send the response to the process manager 105. In this case, since a time required for the preparation process, varies for each process, a time to respond to the process manager 105 may vary for each process.

When the process21 131 first completes the preparation process, the process21 131 sends the response to the process manager 105 (S310) and performs the allocated role (S315).

In this case, the process manager 105 generates the status change event notifying that the process21 131 starts performing the role and transmits the generated status change event to other processes (S320). Therefore, the residual processes other than the process21 131 may confirm a status of the process21 131 from the status change event during ‘S320’ (S325).

Thereafter, when the process23 133 completes the preparation, the process23 133 sends the response, to the process manager 105 (S330) and performs the allocated role (S335). In this case, the process manager 105 generates the status change event notifying that the process23 133 starts performing the role and transmits the generated status change event to other processes (S340). Therefore, the residual processes other than the process23 133 may confirm a status of the process23 133 from the status change event during ‘S340’ (S345).

Herein, since the process32 142 has dependency on the process23 133, the process32 142 may operate after the process23 133 starts performing the role. On the contrary, since the process31 141 has dependency on the process22 132 and the process23 133, the process31 141 may not operate while the process22 132 does not perform the role.

Therefore, the process32 142 may complete the preparation process when confirming that the process23 133 performs the role during ‘S345’. Therefore, when the process32 completes the preparation process, the process32 142 sends the response to the process manager 105 (S350) and performs the allocated role (S355). In this case, the process manager 105 generates the status change event notifying that the process32 142 starts performing the role and transmits the generated status change event to other processes (S360). Therefore, the residual processes other than the process32 142 may confirm the status of the process32 142 from the status change event during ‘S360’ (S365).

Thereafter, when the process22 132 completes the preparation process, the process22 132 sends the response to the process manager 105 (S370) and performs the allocated role (S375). In this case, the process manager 105 generates the status change event notifying that the process22 132 starts performing the role and transmits the generated status change event to other processes (S380). Therefore, the residual processes other than the process22 132 may confirm the status of the process22 132 from the status change event during ‘S380’ (S385).

In this case, the process31 141 may confirm that the process23 133 starts performing the role during ‘S345’ and confirm that the process22 132 starts performing the role during ‘S385’. Therefore, when the process31 141 completes the preparation process, the process31 141 sends the response to the process manager 105 (S390) and performs the allocated role (S395). In this case, the process manager 105 generates the status change event notifying that the process31 141 starts performing the role and transmits the generated status change event to other processes (S400). Therefore, the residual processes other than the process31 141 may confirm the status of the process31 141 from the status change event during ‘S400’ (S405).

By such a scheme, since the process manager 105 sends the response when the process having dependency operates based on status information confirmed through the status change event at each process side in allocating the processes to the networking service space 130 and the networking application space 140, the process manager 105 may control the life-cycle without considering the dependency of each process.

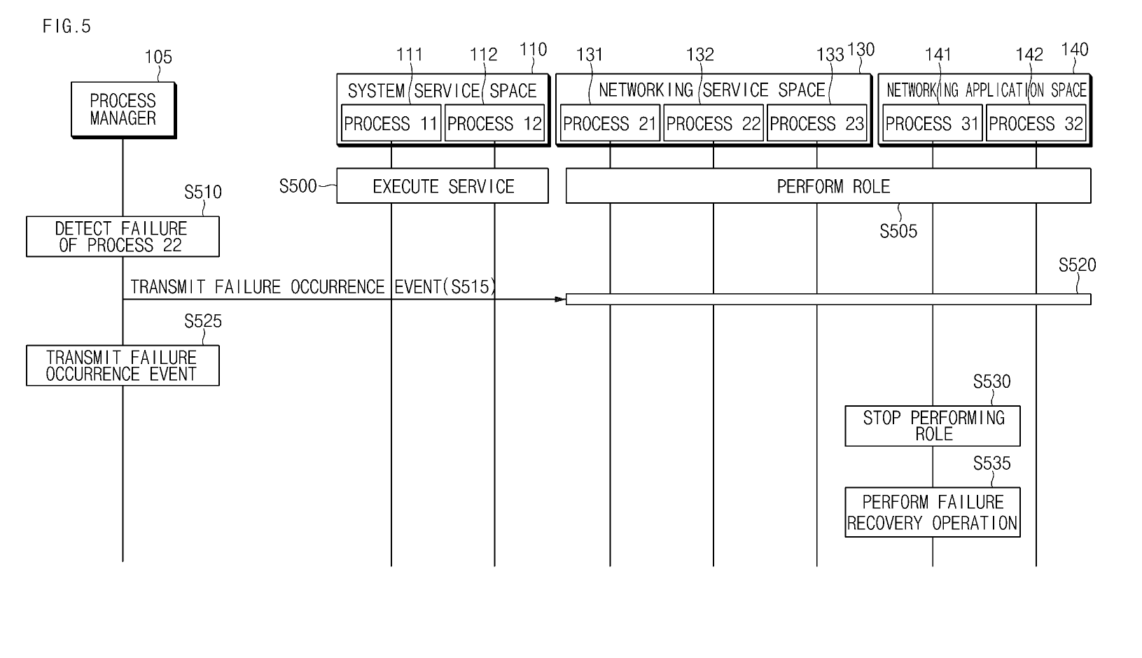

FIG. 5 is a flowchart illustrating a fourth exemplary embodiment of the method for controlling a life-cycle of a process for a network operating system according to the present invention. In particular, FIG. 5 illustrates an operation in which the process manager 105 processes the failures of the processes of the system service space 110, the networking service space 130, and the networking application space 140.

Referring to FIG. 5, the process11 111 and the process12 112 of the system service space 110 execute the services (S500), and while the process21 131 to the process23 133 of the networking service space 130 and the process31 141 and the process32 142 of the networking application space 140 perform the roles allocated thereto (S205), the process manager 105 may detect the failures which occur in the processes. In this case, a scheme in which the process manager 105 detects the failures is not limited to any one and the failures of the respective processes may be detected by using various types of failure detection schemes which are generally used. Further, the process manager 105 may detect the failure through the health check result of each process.

When the process manager 105 detects the failure of the process22 132 (S510), the process manager 105 generates a failure occurrence event for the process22 132 and transmit the failure occurrence event to the processes that operate in the networking service space 130 and the networking application space 140 (S515). In this case, the processes that operate in the networking service space 130 and the networking application space 140, that is, the process21 131, the process23 133, the process31 141, and the process32 142 receive the failure occurrence event transmitted from the process manager 105 to confirm a failure status of the process22 132 (S520).

Thereafter, the process manager 105 performs a failure recovery operation for the process22 132 (S520).

Meanwhile, the process31 141 confirms that the failure occurs in the process22 132 having the dependency through ‘S520’. In this case, since the process31 141 may not perform the role due to the failure of the process22 132, the process31 141 stops performing the role (S530). Thereafter, the process31 141 performs the failure recovery operation of itself (S535) to cope with the failure of the process22 132 having the dependency.

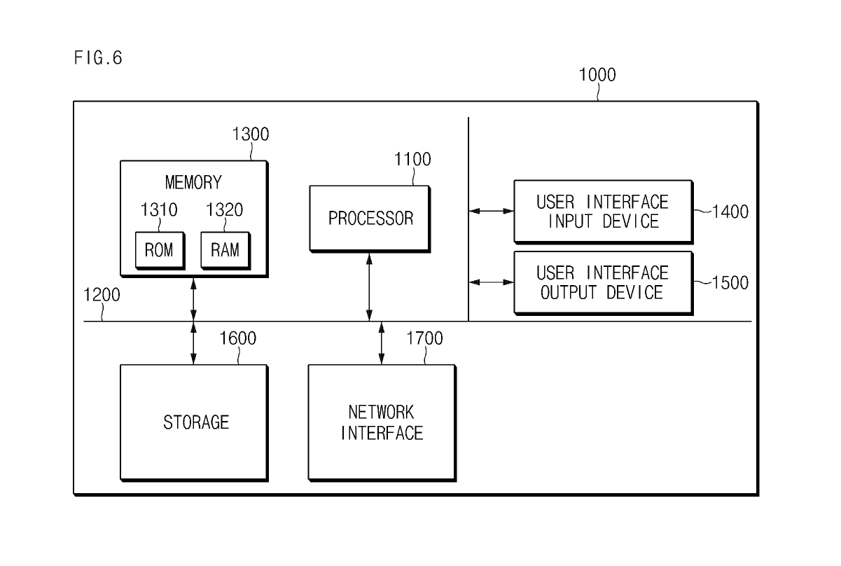

Meanwhile, FIG. 6 is a diagram illustrating a computing system to which the apparatus according to the present invention is applied.

Referring to FIG. 6, a wireless communication terminal according to the present invention may include a processor 1100, a memory 1300, a user interface input device 1400, a user interface output device 1500, a storage 1600, and a network interface 1700. The respective units of the wireless communication terminal 1000 may be connected with each other by a bus 1200.

The user interface input device as a means for receiving a control command from a user may correspond to a key button implemented outside the wireless communication terminal or correspond to a soft key implemented on a display of the wireless communication terminal. Further, the user interface input device may be an input means of a type such as a mouse, a joystick, a jog shuttle, or a stylus pen.

The user interface output device 1500 may include a display on which an operating status and an operating result of the wireless communication terminal are displayed and include a speaker that guides the operating status and the operating result through a voice.

Herein, when the display includes a sensor sensing a touch operation, the display may be used as an input device in addition to an output device. That is, when a touch sensor such as a touch film, a touch sheet, a touch pad, or the like is provided in the display, the display may operate as a touch screen and may be implemented as a type in which the user interface input device and the user interface output device 1500 are integrated with each other.

In this case, the display may include at least one of a liquid crystal display (LCD), a thin film transistor-liquid crystal display (TFT LCD), an organic light-emitting diode (OLED), a flexible display, a field emission display (FED), and a 3D display.

The memory 1300 and the storage 1600 may include various types of volatile or non-volatile storage media. As one example, the storage 160 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM) or at least one of the ROM and the RAM.

The network interface 1700 is a device that processes a signal transmitted/received through the network by using wired/wireless Internet communication technology. Herein, the wireless Internet communication technology may include a wireless LAN (WLAN), wireless broadband (Wibro), world interoperability for microwave access (Wimax), high speed downlink packet access (HSDPA), and the like. Further, the wired Internet communication technology may include universal serial bus (USB) communication, and the like.

The processor 1100 may be a semiconductor device that processes commands stored in a central processing unit (CPU) or the memory 1300 and/or the storage 1600.

Steps of a method or an algorithm described in association with the exemplary embodiments disclosed in the specification may be directly implemented by hardware and software modules executed by the processor 1100, or a combination thereof. The software module may reside on storage media (that is, the memory 1300 and/or the storage 1600). The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As yet another method, the processor and the storage medium may reside in the user terminal as individual components.

Hereinabove, although the present invention has been described by specific matters such as detailed components, limited exemplary embodiments, and drawings, they have been provided only for assisting in the entire understanding of the present invention. Therefore, the present invention is not limited to the exemplary embodiments. Various modifications and changes may be made by those skilled in the art to which the present invention pertains within the scope without departing from an essential characteristic of the present invention. The spirit of the present invention should not be defined only by the described exemplary embodiments, and it should be appreciated that claims to be described below and all technical spirit which are evenly or equivalently modified are included in the claims of the present invention.

What is claimed is:

1. A method for controlling a life-cycle of a process of a network operating system, the method comprising:
by a process manager,
transmitting a first initialize command to processes in a system service space of the network operating system and registering processes that respond to the first initialize command when an operation of the network operating system starts;
confirming failure statuses of the processes registered in response to the first initialize command and controlling the registered processes to execute a designated service;
transmitting, when the processes in the system service space execute the service, a second initialize command to processes in a networking service space and a networking application space and registering processes that respond to the second initialize command; and
confirming failure statuses of the processes registered in response to the second initialize command and allocating roles to the respective processes in the networking service space and the networking application space.

2. The method of claim 1, wherein the process in the system service space provides a service designated to correspond to any one of inter process communication (IPC), an event, a checkpoint, a task, and a memory to the processes in the networking service space and the networking application space.

3. The method of claim 1, wherein the process in networking service space provides to the processes in the networking application space a service corresponding to a role allocated to correspond to any one of a command manager, a routing information base (RIB) manager, a link manager, and a policy manager.

4. The method of claim 1, wherein the process in the networking application space processes an operation corresponding to a role allocated to correspond to any one application protocol among a routing information protocol (RIP), an open shortest path first (OSPF) protocol, a border gateway protocol (BGP), a link aggregation control protocol (LACP), and a spanning tree protocol (STP).

5. The method of claim 1, further comprising:
by the process manager,
after the allocating of the roles to the respective processes in the networking service space and the networking application space, receiving a response from at least one of the processes to which the roles are allocated;
generating a status change event for role performance of the process receiving the response; and
transmitting the status change event to other processes except for the process receiving the response.

6. The method of claim 5, further comprising:
confirming the respective processes in the networking service space and the networking application space to confirm statuses of other processes by the status change event.

7. The method of claim 5, further comprising:
confirming, by at least one of the respective processes in the networking service space and the networking application space, role performance statuses of other processes providing a service required to perform the role of the corresponding process by the status change event.

8. The method of claim 7, further comprising:
when another process providing the service required to perform the role of the corresponding process starts performing the role, sending, by the corresponding process, the response to the process manager.

9. The method of claim 1, further comprising:
responding, by the processes allocated with the roles by the process manager, to the process manager and thereafter, performing the allocated roles.

10. The method of claim 9, further comprising:
by the process manager,
when detecting failures of the processes that perform the roles allocated by the process manager, generating a failure occurrence event for the process of which the failure is detected;
transmitting the failure occurrence event to the processes in the networking service space and the networking application space; and
performing a failure recovery operation for the process of which the failure occurs.

11. The method of claim 10, further comprising:
confirming, by the respective processes in the networking service space and the networking application space, the process of which the failure occurs by the failure occurrence event.

12. The method of claim 11, further comprising:
when the process of which the failure occurs is the process providing the service required to perform the role of the corresponding process, stopping performing the role of the corresponding process; and
performing, by the corresponding process, the failure recovery operation.

13. The method of claim 1, further comprising:
by the process manager,
transmitting a role stop command to the processes that operate in the networking service space and the networking application space;
generating status events for processes that respond to the role stop command and transmitting the generated status events to the processes in the networking service space and the networking application space;
when all of the roles of the processes that operate in the networking service space and the networking application space stop, controlling the respective processes to end; and
controlling the processes that operate in the system service space to end after all of the processes in the networking service space and the networking application space end.

14. The method of claim 13, further comprising:
confirming the respective processes in the networking service space and the networking application space, the process that stops performing the role by the status change event.

15. The method of claim 14, further comprising:
when the process that stops performing the role is the process providing the service required to perform the role of the corresponding process, stopping performing the role of the corresponding process.

16. An apparatus for controlling a life-cycle of a process for a network operating system, the apparatus comprising:
multiple processes that operate in a system service space, a network service space, and a network application space of the network operating system; and
a process manager controlling life-cycles of the multiple processes,
wherein the process manager controls execution of services of the processes in the system service space and thereafter, allocates roles to the respective processes in the network service space and the network application space at the time of starting an operation of the network operating system and control the respective processes in the network service space and the network application space to end and thereafter, controls the processes in the system service space to end when the operation of the network operating system ends.

17. The apparatus of claim 16, wherein the process manager generates a status change event including information on a process performing an allocated role among the processes in the network service space and the network application space and provides the generated status change event to other processes, and
at least one of the respective processes in the networking service space and the networking application space confirms, role performance statuses of other processes providing a service required to perform the role of the corresponding process by the status change event.

18. The apparatus of claim 16, wherein the process manager generates a failure occurrence event including information on a process of which a failure occurs among the processes in the network service space and the network application space and provides the generated failure occurrence event to other processes, and
at least one of the respective processes in the networking service space and the networking application space confirms a failure status of the process providing a service required to perform the role of the corresponding process by the failure occurrence event.
